(19) United States
(12) Patent Application Publication
(10) Pub. No.: US 2020/0327476 A1
(43) Pub. Date: Oct. 15, 2020

(54) DYNAMIC QUALITY CONTROL IN PETROCHEMICAL, CHEMICAL, AND PHARMACEUTICAL MANUFACTURING PROCESSES

(71) Applicant: ExxonMobil Research and Engineering Company, Annandale, NJ (US)

(72) Inventors: Eric S. Shi, Guilin View (SG); George A. Khoury, Beaumont, TX (US); Coila F. LaFleur, Baton Rouge, LA (US)

(21) Appl. No.: 16/830,093

(22) Filed: Mar. 25, 2020

Related U.S. Application Data
(60) Provisional application No. 62/831,777, filed on Apr. 10, 2019.

(51) Int. Cl. G06Q 10/06; G06K 9/62; G06N 20/00

(52) U.S. Cl. CPC G06Q 10/06395; G06N 20/00; G06K 9/6257; G06K 9/6251

(57) ABSTRACT

A dynamic quality control method for a chemical manufacturing process to maintain one or more products within quality and/or technical specification(s) can include measuring properties of feed-stock, intermediates, and the products to yield respective quality vectors; assigning a node specification to each of the feed-stocks, the intermediates, and the products, wherein the node specifications for the feed-stocks and the intermediates are dynamic node specifications; calculating conversion tensors to correlate any pairs of node specifications; comparing the quality vectors to the corresponding dynamic node specification(s); identifying a quality deficit and/or a quality surplus associated with each of the quality vectors based on the comparison to the corresponding dynamic node specification(s); and compensating for the quality deficit and/or the quality surplus by (A) adjusting conditions of the manufacturing process and/or (B) compensating the quality deficits with the quality surpluses via material transfer and re-blending processes.

### CROSS REFERENCE TO RELATED APPLICATION

This application claims priority to U.S. Provisional Application 62/831,777 filed Apr. 10, 2019, which is herein incorporated by reference in its entirety.

### BACKGROUND

The present disclosure relates to quality control of a product in a manufacturing process. The product is a single compound or a mixture of compounds.

In the chemical manufacturing industries (e.g., pharmaceuticals, commodity chemicals, petroleum refining, lubricant manufacturing, and the like), quality control is typically defined by product specifications. The product specifications can include permitted ranges of properties like boiling point, purity, relative concentrations of two or more components of the product, density, degree of isomerization, and the like.

Typically, the operation parameters at each of the steps of a manufacturing process (e.g., temperatures, pressures, mass flow rates, catalytic activities, separation ratios and control of impurity concentrations) are determined based on empirical operation knowledge to produce a product that is expected to be within the product specifications. After a product is produced, it is tested to confirm and to certify that the product is in compliance with the product quality specification. If the product is out of the quality specification, the operation parameters of the manufacturing process are adjusted, again based on historical experiences, and the product is re-processed and retested against the quality specification until full compliance is achieved. Such a quality control scheme can be termed as “quality control in the end.” All current prevailing quality control schemes in the chemical, petrochemical, pharmaceutical, and etc. industries share this key characteristic.

Because quality control is performed only after the manufacturing process is complete, these manufacturing industries share the following four weaknesses: (1) lack of precise definition of quality requirements on the in-process intermediates (only the quality requirements of the final products are defined in most of the cases), and consequently, lack of capability to identify manufacturing errors on real-time basis as they occur, especially when such errors occur to the in-process intermediates (rather than to the final products); (2) as a consequence of (1), lack of capability to detect quality fluctuations, i.e., quality surpluses (e.g., as a consequence of over-manufacturing) at certain stages of the manufacturing streams vs. quality deficits (e.g., as a consequence of under-manufacturing) at certain other stages of the manufacturing streams, as well as the quality fluctuations in raw material and additive supply; (3) as a consequence of (1) and (2), lack of capability of offsetting quality deficits formed and/or about to be formed at certain parts of some manufacturing streams with quality surpluses generated and/or about to be generated at parts of other manufacturing streams; and (4) lack of a broad capability in searching for global optimization maximums and/or global optimization minimums far away from what the experience-based local optimizations can suggest.

### SUMMARY

The present disclosure relates to the dynamic quality control scheme addressing fluctuations in quality at any part of the manufacturing network by detecting, quantifying, and predicting quality surpluses and quality deficits at any given step of any given manufacturing stream, and by compensating quality deficits formed and/or about to be formed at certain parts of some manufacturing streams with quality surpluses generated and/or about to be generated at other parts of the same and/or different manufacturing streams. Such a dynamic quality control system will uplift the manufacturing competitiveness, especially for the integrated manufacturers that operate multiple manufacturing chains and/or streams in parallel, to a completely new level.

As used herein, the term “chemical manufacturing” encompasses pharmaceutical manufacturing, commodity chemical manufacturing, petroleum refining, lubricant manufacturing, and the like.

An example embodiment of the present disclosure is a dynamic quality control method for a chemical manufacturing process to maintain one or more products within respective quality and/or technical specification(s), wherein the manufacturing process converts one or more feed-stocks into one or more products via one or more intermediates, the method comprising: measuring properties of the feed-stock, the intermediates, and the products to yield their respective quality vectors; assigning a node specification to each of the feed-stocks, the intermediates, and the products, wherein the node specifications for each of the feed-stocks and the intermediates are dynamic node specifications; calculating conversion tensors to correlate any pairs of node specifications; comparing one or more quality vectors to the corresponding dynamic node specification(s); identifying a quality deficit and/or a quality surplus associated with each of the one or more quality vectors based on the comparison to the corresponding dynamic node specification; and compensating for the quality deficit and/or the quality surplus by (A) adjusting conditions of the manufacturing process in response to the quality deficit and/or the quality surplus and/or (B) compensating quality deficits with corresponding quality surpluses via material transfer and re-blending processes.

Another example embodiment of the present disclosure is a system for providing a chemical manufacturing process to maintain one or more products within a static and/or dynamic quality specification, wherein the manufacturing process converts one or more feed-stocks into one or more products via one or more intermediates, the system comprising: a processor; a non-transitory machine readable medium that stores machine-readable instructions for execution by the processor, the machine-readable instructions comprising: measuring properties of the feed-stock, the intermediates, and the products to yield one or more quality vectors; assigning a node specification to each of the feed-stocks, the intermediates, and the products, wherein the node specifications for each of the feed-stocks and the intermediates are dynamic node specifications; calculating conversion tensors to correlate any pairs of node specifications; comparing one or more quality vectors to the corresponding dynamic node specification(s); identifying a quality deficit and/or a quality surplus associated with each of the one or more quality vectors based on the comparison to the corresponding dynamic node specification(s); and compensating for the quality deficit and/or the quality surplus by (A) adjusting conditions of the manufacturing process in response to the quality deficit and/or the quality surplus and/or (B) compensating quality deficits with corresponding quality surpluses via material transfer and re-blending processes.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1A is a simplified flow chart of a chemical manufacturing process for the conversion of α+β→ε. FIG. 1B is a network representation of the manufacturing process of FIG. 1A.

FIG. 2A is a simplified flow chart of a chemical manufacturing process for the conversion of α+β→ε with recycling of feed-stocks α and β in the manufacturing process. FIG. 2B is a network representation of the manufacturing process of FIG. 2A.

### DETAILED DESCRIPTION

The present disclosure relates to dynamic quality control of a chemical manufacturing process over the entire manufacturing network that accounts for changes in feed-stock qualities, changes in intermediate compositions, and costs associated with the manufacturing process. When describing feed-stocks, intermediates, and products herein, it is not implied that such is a single chemical component. Rather, each may be a single chemical component or a mixture of chemical components.

The dynamic quality control systems and methods described herein leverage artificial intelligence in order to realize real-time predictions of and remedies for manufacturing errors of intermediate quality and intermediate compositions, and to increase responsiveness to fluctuations in quality and cost of raw material and additives. The methods and systems described herein can be applied to a variety of chemical manufacturing processes that include, but are not limited to, pharmaceutical manufacturing, commodity chemical manufacturing, petroleum refining, lubricant manufacturing, and the like.

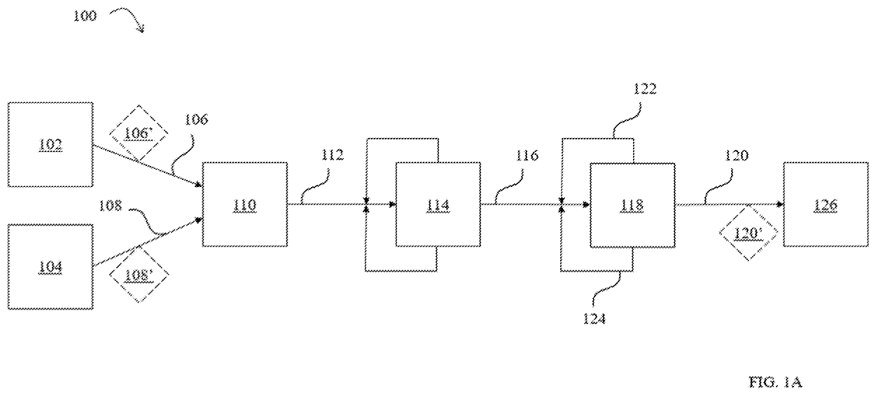

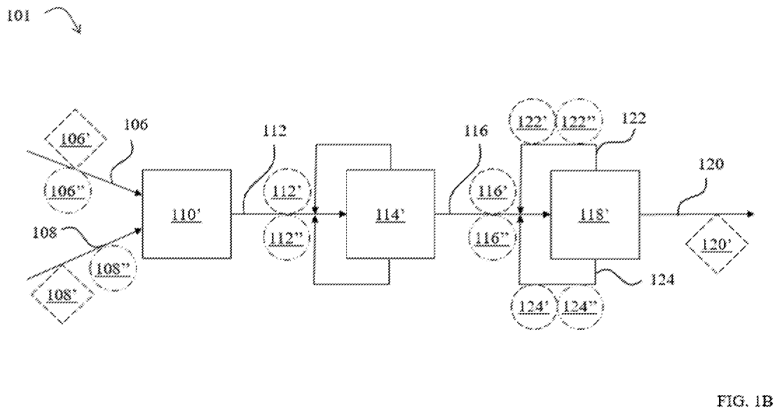

FIG. 1A is a simplified flow chart of a chemical manufacturing process 100 for the reaction α+β→ε. Briefly, a feed-stock comprising α and a feed-stock comprising β are mixed and reacted to produce a product comprising ε.

In the illustrated key steps of the manufacturing process 100, storage tanks (or other suitable pipelines, tankers, or the like) 102 and 104 contain and supply feed-stock stream 106 and feed-stock stream 108, respectively, for the manufacturing process 100. The feed-stock streams 106 and 108 are mixed in mixer 110 to produce intermediate stream 112 comprising α and β, which is reacted in reactor 114 to produce intermediate stream 116 comprising ε, unreacted α, and unreacted β. The intermediate stream 116 is separated in distillation unit 118 to remove at least portions of the unreacted α and unreacted β. As a result, the distillation unit 118 has three streams coming therefrom: product stream 120 comprising mainly ε, but also small amounts of the unreacted α and unreacted β, overhead stream 122 comprising α, and bottom stream 124 comprising β. The product stream 120 is transported to a storage tank (or other suitable pipeline, tanker, or the like) 126 or other portion of a manufacturing plant.

In the illustrated manufacturing process 100, the quality specifications for 106′, 108′, and 120′ are each associated with the respective feed-stock streams 106 and 108 and the product stream 120. As used herein, the term “quality specification” refers to a listing of physical properties and/or chemical properties of a single compound or a mixture of compounds. The physical properties and/or chemical properties included in the quality specification are different depending on the manufacturing process and industry. Further, each quality specification within the same manufacturing process can include different physical properties and/or chemical properties, depending on the details of the underlying manufacturing unit. Examples of physical properties and chemical properties that may be included in a quality specification can include, but are not limited to, concentrations of selected individual components in the composition, intended purity levels of products, level of contaminants, density, viscosity, lubricity, freeze point, melting point, flash point, boiling point, energy content, heat value, octane number, cetane number, color, odor, melt index, flow rate index, impact strength, tensile strength, elongation at break, molecular weight characteristics (e.g., weight-average molecular weight (Mw), number-average molecular weight (Mn), z-average molecular weight (Mz), and/or polydispersity index (PDI=Mw/Mn)), chirality, and the like, and any combination thereof.

In traditional manufacturing processes, the quality specification 120′ of the product stream 120 is defined by a market, a customer, the manufacturer, or other suitable party. The quality specifications 106′ and 108′ for the feed-stock streams 106 and 108 are set by the vendors of these feed-stocks. The quality specifications of the intermediate streams 112 and 116 are traditionally not defined.

In traditional manufacturing processes, quality specifications are defined only for final products (i.e., not for any intermediates leading to the final products) and are static in nature, as they do not change over minutes, hours, days, and, in some instances, not over years. The corresponding operation parameters of a manufacturing process are also set statically, typically based on historical knowledge of previous runs of the manufacturing process. Examples of parameters that can be associated with one or more steps of a manufacturing process include, but are not limited to, reaction severities (as often manifested by the combination of temperature and pressure), temperature distribution across zones of a manufacturing unit, pressure and partial pressure distributions across zones of a manufacturing unit, material flow rate, split ratios, reactant stoichiometric ratios, reactor efficiency, mixing and separation efficiencies, catalytic contact time, catalyst activity, and the like, and any combination thereof. The nature and numerical values of the parameters are dependent on the manufacturing processes, techniques employed to execute the processes, and the designs and fabrication details of the manufacturing units as well as the industry.

In contrast to such manufacturing processes under these conventional quality control schemes, the present disclosure presents a dynamic quality control scheme that addresses all four weaknesses described herein. More specifically, the dynamic quality control scheme first starts with defining precisely the quality requirements for each of the manufacturing steps. Since each of the manufacturing steps is represented by a node in the manufacturing network, such a set of requirements is termed as dynamic node specification. Each node of the manufacturing network has a dynamic node specification. Such dynamic node specifications are interconnected. Because the dynamic node specifications are dynamic (not static), they change in coherence with one another as dictated by the mathematical equations that correlate them.

As a consequence of the first attribute, the dynamic quality control scheme secondly enables detection and quantification of quality surpluses and quality deficits at any given stage of any given manufacturing stream by comparing the actual quality of the given stream at the given stage with the corresponding dynamic node specification. This, in turn, enables the real-time digital manufacturing in each of the manufacturing chains (streams) and brings the user's manufacturing competitiveness to a completely new level.

In conjunction with the second attribute, the dynamic quality control scheme thirdly has the capability of compensating quality deficits formed and/or about to be formed at certain parts of some manufacturing streams with quality surpluses generated and/or about to be generated at parts of other manufacturing streams. Such compensating ability uplifts the manufacturing competitiveness of integrated manufacturers (e.g., that operate multiple manufacturing chains and/or streams in parallel) to yet another new level.

A fourth attribute of the dynamic quality control scheme is the capability to search for global optimums in the inter-related manufacturing parameters, which may be far away from the experience-based manufacturing parameters currently implemented. This attribute can potentially revolutionize the manufacturing industries.

Because of the large quantities of real-time calculations and computer-based decision makings at each of the nodes and across the network of manufacturing, the methods and systems of the present disclosure can employ artificial intelligence to achieve the desired dynamic quality control over the manufacturing network. More specifically, artificial intelligence can be used to inter-relate node specifications across the chemical manufacturing process network to identify the best solutions dynamically and direct the execution of such solutions proactively and dynamically.

Generally, in a manufacturing network, the streams of materials (feed-stocks, intermediates, and products) that are passing through the manufacturing units (as represented by their respective nodes herein) are to be converted, transformed, purified, and/or isolated into a single compound or a mixture of compounds suitable for next step of the manufacturing. Each of such manufacturing units (as represented by its respective node) is designed to execute such an action to meet the quality requirements stipulated by the dynamic node specification.

Whereas actual quality of a stream of the chemicals exiting a node can be expressed by a quality vector (e.g., with the following vector components: density=0.81 g/mL; impurity A=0.033 mol %; impurity H=0.027 mol %; tensile strength=77 MPa), the dynamic node specification provides a reference range for each of the components (e.g., density: 0.80 g/mL to 0.83 g/mL; impurity A: <0.038 mol %; impurity H: <0.025 mol %; tensile strength: 80 MPa to 90 MPa) to meet the desired quality expectations. In this hypothetical case, the concentration level of impurity H will be deemed too high (off the dynamic node specification upper limit) and tensile strength too low (off the dynamic node specification lower limit), whereas all other components of the quality vector (and therefore the actual quality of the underline stream of the material) are meeting the quality requirements as stipulated by the dynamic node specification.

Within the network representation 101 each of the streams 106, 108, 112, 116, 120, 122, and 124 are associated with quality vectors 106″, 108″, 112″, 116″, 120″, 122″, and 124″, respectively. The quality vector is a real-time measurement of the physical properties and chemical properties of the corresponding stream. Examples of physical properties and chemical properties that may be included in a quality vector can include, but are not limited to, concentrations of selected individual components in the composition, intended purity levels of products, level of contaminants, density, viscosity, lubricity, freeze point, melting point, flash point, boiling point, energy content, heat value, octane number, cetane number, color, odor, melt index, flow rate index, impact strength, tensile strength, elongation at break, molecular weight characteristics (e.g., weight-average molecular weight (Mw), number-average molecular weight (Mn), z-average molecular weight (Mz), and/or polydispersity index (PDI=Mw/Mn)), chirality, and the like, and any combination thereof.

During the manufacturing process, the quality vectors are compared to their corresponding dynamic node specification to identify quality deficits and quality surpluses in the manufacturing process. For example, the properties of intermediate stream 116, as represented by the quality vector 116″, are compared to the corresponding dynamic node specification 116′ during manufacturing. If the intermediate stream 116 has a concentration of c higher than what is stipulated in the dynamic node specifications 116′ (which results in a quality surplus of the concentration), then the separator may be operated under different conditions that may be less energy intensive and/or the relative concentration of reactants in mixer 110 can be altered to produce a product stream 120 that is still within the purity of c required by the node specifications 120′. The network representation 101 can also take into account the cost of each of these variables and determine which one of the options provides greater cost savings. After implementing such changes, not only values of the respective components of the quality vectors will change, the respective dynamic node specifications may also need to be adjusted to reflect the changed manufacturing conditions. Such analyses are performed in real-time to identify and correct quality deficits and quality surpluses continuously.

As used herein, the term “quality surplus” refers to a physical and/or chemical property of a substance (one compound or a mixture of compounds) being greater than the physical and/or chemical property defined (as a value or a range) in the dynamic node specification. As used herein, the term “quality deficit” refers to a physical and/or chemical property of a substance (one compound or a mixture of compounds) being less than the physical and/or chemical property defined (as a value or a range) in the dynamic node specification.

When a quality surplus or a quality deficit is identified in the manufacturing process, the corresponding operation parameters and/or conditions (e.g., temperature, pressure, catalyst activity, split ratio, and recycling percentage) of the manufacturing unit(s) can be changed to address the issue(s) immediately and in proportion to optimize or improve efficiency and efficacy of the manufacturing process. As operation parameters and/or conditions of the manufacturing unit(s) change, the dynamic node specification(s) of the involved and/or related node(s), in turn, can be adjusted to take full advantage of the changed operation parameters distribution and changed quality vector distribution across the manufacturing network.

Any adjustment to a dynamic node specification at a given node will affect the directions and magnitudes of changes of the dynamic node specifications of the neighboring and/or nearby nodes, and vice versa. The influences and/or restrictions of a change of a dynamic node specification at any given node to those of all of its neighboring nodes can be mathematically expressed by respective tensors. When a tensor takes its simplest form, being one-dimensional, the respective pair of dynamic node specifications are inter-correlated via a mathematical equation. As used herein, the terms “tensor” and “conversion tensor” are used interchangeably to describe the unique relationship of two dynamic node specifications across any given node. Since all nodes are interconnected either directly (e.g., neighboring nodes) or indirectly (e.g., nodes separated by one or more nodes) in a manufacturing network, calculations and recalculations to update the dynamic node specifications will be iterative and take some computation power to complete. For this reason, deployment of suitable algorithms and artificial intelligence can significantly reduce the demand for computation power, to enable proper handling of large manufacturing networks and to speed up the decision-making by the artificial intelligence that directs the automated dynamic quality control process. More specifically, machine-learning techniques may be used to derive elements of the conversion tensors that inter-relate node specifications in the network representation of the manufacturing process. The machine learning techniques may also be used to derive elements of the tensors that inter-relate the operation parameters and the desirable quality vector at a given node of the manufacturing network.

Referring again to FIGS. 1A and 1B, in one example, [α], [β], [ε], and [imp] are used in the node specifications 106′, 108′, 112′, 116′, 120′, 122′, and 124′ to describe the concentrations of substances α, β, ε, and imp, where imp is for other impurities.

Scenario 1. Points 7-8 are derived from given points 1-6 below for the manufacturing process 100, where the % is all defined as mol %.
1. The node specification 120′ of product stream 120 is [ε]≥99.0%, [α]≤0.4%, [β]≤0.3%, [imp]≤0.3%.
2. The mixer 110 efficiency is 100%.
3. The reactor 114 conversion efficiency is 100%.
4. The distillation unit 118 operates at an efficiency (0≤m≤1), with split ratio of m*0.6% of α and m*0.3% of imp going to the overhead stream 122 of distillation unit 118, and m*0.7% of β and m*0.4% imp going to the bottom stream 124 of distillation unit 118. Number of recycles of the distillation unit 118 is set at n.
5. The initial value of the dynamic node specification 106′ for feed-stock 106 is [α]≥99.4%, [imp]≤0.6%.
6. The initial value of the dynamic node specification 108′ for feed-stock 108 is [β]≥99.2%, [imp]≤0.8%.
7. The [α], [β], [ε], and [imp] requirements for the dynamic node specification 116′ can be calculated as illustrated in Eqs. 1-4.

[ε]≥99.0%−(0.6%*m+0.7%*m+0.7%*m)ⁿ=99.0%−(2.0%)ⁿ*(m)ⁿ Eq. 1

[α]≤0.4%+0.6%*m Eq. 2

[β]≤0.3%+0.7%*m Eq. 3

[imp]≤0.3%+(0.3%*m+0.4%*m)=0.3%+0.7%*m Eq. 4
8. Consequently, the dynamic node specification 112′ of intermediate stream 112 can be derived as illustrated in Eqs. 5-7, where the % is defined as mol %.

[α]=½*{99.4%˜99.0%−(2.0%)ⁿ*(m)ⁿ} Eq. 5

[β]=½*{99.2%˜99.0%−(2.0%)ⁿ*(m)ⁿ} Eq. 6

[imp]≤0.3%+0.7%*m Eq. 7
where ½*{99.0%−(2.0%)ⁿ*(m)ⁿ} represents the lower limit of both [α] and [β] in the intermediate stream 112.

In equations herein, the two values on both sides of the ˜ define a range.

These equations illustrate that the quality requirements on a chemical and/or physical property of an intermediate at any given node of a manufacturing network can be related to the quality requirements on the chemical and/or physical properties of the intermediates at other nodes of the same network mathematically using conversion tensors, where the tensor elements consist of mathematical functions containing operation parameters of the underlining manufacturing unit(s).

In the example scenario described above the permitted [α], [β], [ε], and [imp] concentration ranges of the intermediates streams 112 and 116 are correlated to those of feed-stock streams 106 and 108 and the product stream 120. In other words, the node specifications 106′, 108′, and 120′ can now be inter-correlated mathematically. Further, synchronized real-time quality control over each of the nodes of a manufacturing network now becomes feasible. Decisions on adjusting operation parameters, such as the number of recycle times (n) and distillation efficiency (m), can now be made with real-time considerations of the dynamics of operation parameters deployed at other nodes to optimize the overall manufacturing competitiveness.

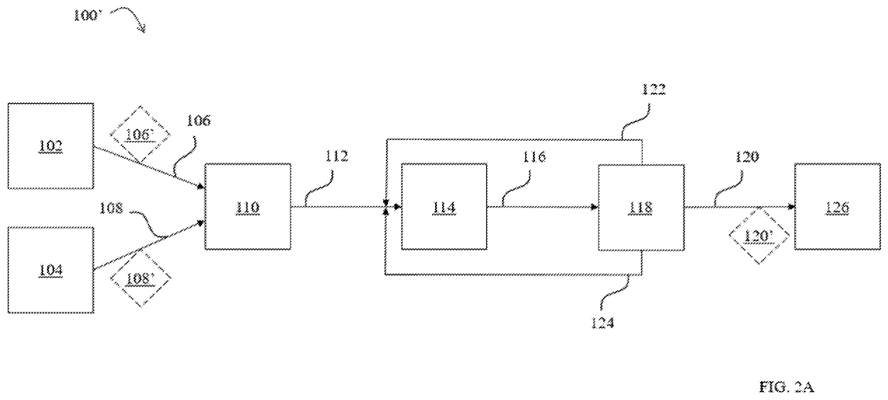

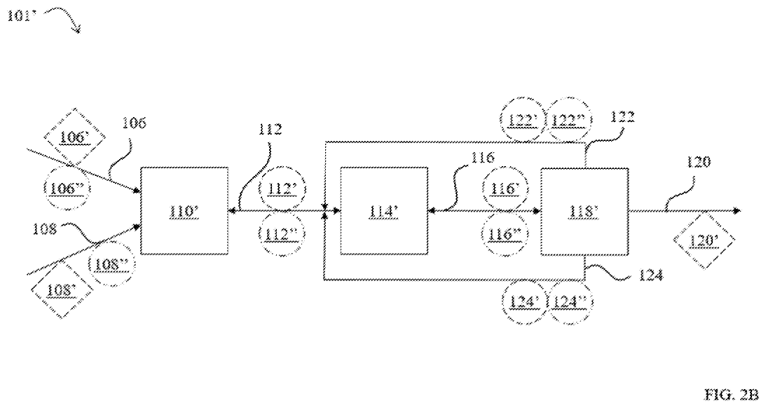

Scenario 2. This scenario is based on a manufacturing process 100′ illustrated in FIG. 2A similar to FIG. 1A. In this example, where the same reference numbers from FIG. 1A apply, the overhead stream 122 and bottom stream 124 of the distillation unit 118 are recycled back to join the intermediate stream 112.

The given points 1, 2, 4, 5, and 6 of Scenario 1 are maintained in Scenario 2, and the following points 9-11 are added as givens in Scenario 2. From these givens, points 12-13 are derived.
9. The reactor 114 conversion efficiency is K (0≤K≤1).
10. Unreacted α is returned from the distillation unit 118 to join the intermediate stream 112, fed into reactor 114, and forced to go through the reaction(s) in the reactor 114 again with the conversion coefficient of K_{αF}, whereas the coefficient controlling the content of α in the overhead stream 122 from the distillation unit 118 is K_{αRO}, and the coefficient controlling the content of α in the bottom stream 124 from the distillation unit 118 is K_{αRB}. Consequently, Eqs. 8-11 hold.

0≤K_{αF}≤1 Eq. 8

0≤K_{αRO}≤1 Eq. 9

0≤K_{αRB}≤1 Eq. 10

K_{αF}+K_{αRO}+K_{αRB}=1(=100 mol %) Eq. 11
11. All unreacted β is returned from the distillation unit 118 to join the intermediate stream 112, fed into reactor 114, and forced to go through the reaction(s), in the reactor 114 again with the conversion coefficient of K_{βF}, whereas the coefficient controlling the content of β in the overhead stream from the distillation unit 118 is K_{βRO}, and the coefficient controlling the content of β in the bottom stream 124 from the distillation unit 118 is K_{βRB}. Consequently, Eqs. 12-15 hold.

0≤K_{βF}≤1 Eq. 12

0≤K_{βRO}≤1 Eq. 13

0≤K_{βRB}≤1 Eq. 14

K_{βF}+K_{βRO}+K_{βRB}=1(=100 mol %) Eq. 15
12. The dynamic node specification 116′ of intermediate stream 116 is the same as that in Scenario 1 (Eqs. 1-4, above).
13. The dynamic node specification 112′ of intermediate stream 112 is now defined by Eqs. 16-20, where p is the number of recycles through the return streams of unreacted α and unreacted β from the distillation unit 118 to join the intermediate stream 112, and the % units are all mol %.

[α]=½*(99.4%˜X_{α}%) Eq. 16

[β]=½*(99.2%˜X_{β}%) Eq. 17

[others]≤0.3%+0.7%*m Eq. 18

X_{α}={99.0%−(2.0%)ⁿ*(m)ⁿ}{K_{αF}/(K_{αF}+K_{αRO}+K_{αRB})}^{p} Eq. 19

X_{β}={99.0%−(2.0%)ⁿ*(m)ⁿ}{K_{βF}/(K_{βF}+K_{βRO}+K_{βRB})}^{P} Eq. 20

Based on point 13, the minimum allowable purity for α in the intermediate stream 120, as represented by X_{α}%, is a function of coefficients K_{αF}/(K_{αF}+K_{αRO}+K_{αRB}). Similarly, the minimum allowable purity for β in the intermediate stream 120, as represented by X_{β}%, is a function of coefficients K_{βF}/(K_{βF}+K_{βRO}+K_{βRB}).

The higher the K_{αF} and K_{βF} (i.e., the higher the reactor efficiency), the lower the [α] and [β] in the intermediate stream 112 is permitted. Consequently, cheaper feed-stocks can be used. However, additional recycles of unreacted feed-stock may be needed to compensate.

A generic formula for optimizing one product over other products in a product portfolio (or one particular chemical or physical property over others) is expressed in Eq. 21, where Eq. 21 reduces to K_{αF}/(K_{αF}+K_{αRO}+K_{αRB}) when parameter a₀=0, i=αF, i+1=αRO, i+2=αRB, and n=i+2.

f(i)=a₀+Kᵢ/Σᵢ₌₁ⁿKᵢ Eq. 21

Scenario 3. This scenario is based on the manufacturing process 100′ of FIG. 2A that operates in a continuous mode. Accordingly, the network framework 101′ of FIG. 2B applies to this scenario. The given points of Scenario 2 are maintained in Scenario 3. However, because the operation is in continuous mode, Eqs. 19 and 20 are replaced with Eqs. 22-23 and 24-25, respectively.

X_{α}={99.0%−(2.0%)ⁿ*(m)ⁿ}(Σᵢ₌₀^{p}aᵢKᵢⁱ) Eq. 22

aᵢ=Kₗᵢ/Σₗ₌₁ⁿKₗᵢ Eq. 23

X_{β}={99.0%−(2.0%)ⁿ*(m)ⁿ}(Σⱼ₌₀^{p}bⱼKⱼ^{j}) Eq. 24

bⱼ=Kₗⱼ/Σₗ₌₁ⁿKₗⱼ Eq. 25

In each of the three foregoing scenarios, the quality vectors 106″ and 108″ for the feed-stocks streams 106 and 108, the quality vectors 122″ and 124″ for the reactor overhead stream 122 and reactor bottom stream 124, and the quality vector 112″ of the intermediate stream 112 can be compared to the corresponding dynamic node specification to identify quality deficits and quality surpluses at the respective nodes. When quality surpluses and/or quality deficits are identified, (1) the manufacturing parameters at the respective nodes can be changed accordingly, and/or (2) the materials flows can be altered accordingly to avoid the undesirable accumulation of over-manufacturing and/or under-manufacturing. This strategy maximizes resource efficiency and efficacy of the manufacturing process and achieves higher competitiveness in an era of digital manufacturing.

The foregoing three scenarios illustrate the process flow of implementing the methods and systems of the present disclosure. In reality, manufacturing processes are much more complex than the scenarios provided. In more complex scenarios, multi-dimensional tensors can be used to relate the dynamic quality requirements of a node to those of other nodes of the manufacturing network, to enable real-time calculations of quality surpluses and quality deficits as they occur, to respond to these issues timely, and even to predict the emergences of such surpluses and deficits and to eliminate them proactively.

As a first example, in the case of a section of a lubricant blending plant, if the dynamic node specification for a stream, leaving previous node and entering the node in question, has three control items on it, namely C₁ (e.g., representing concentration of blending stock 1), C₂ (e.g., representing concentration of blending stock 2), and C₃ (e.g., representing concentration of an additive 3), and if the dynamic node specification for a stream, leaving a previous node, has two control items on it, namely D₁ (e.g., representing viscosity of the leaving stream) and D₂ (e.g., representing density of the leaving stream) leaving the unit, the conversion tensor linking the 2 dynamic node specifications will assume the 3×2 format of a matrix, as illustrated in Eq. 26.

$$( {D}_{1} , {D}_{2} ) = ( {C}_{1} , {C}_{2} , {C}_{3} ) [ \begin{matrix}{k}_{11} {k}_{12} \\ {k}_{21} {k}_{22} \\ {k}_{31} {k}_{32}\end{matrix} ] \qquad Eq . 26$$

In another example, as illustrated in Eq. 27, if G₁, G₂, and G₃ represent 3 dynamic node specifications (each is a list containing corresponding control ranges of multiple physical and/or chemical properties to be controlled) for the 3 streams entering into the node, and H₁ and H₂ represent 2 dynamic node specifications (each is another list containing corresponding control ranges of multiple physical and/or chemical properties to be controlled) for the 2 streams leaving the node, the conversion tensor linking these 2 sets of dynamic node specifications will assume the 3×2 format of a matrix, as illustrated in Eq. 27, where each of the Hⱼ (j=1, 2) and Gⱼ (i=1, 2, 3) is a multi-dimensional vector in this notation of Eq. 27. Each of the tensor element, uᵢⱼ, is a tensor by itself.

$$( {H}_{1} , {H}_{2} ) = ( {G}_{1} , {G}_{2} , {G}_{3} ) [ \begin{matrix}{u}_{11} {u}_{12} \\ {u}_{21} {u}_{22} \\ {u}_{31} {u}_{32}\end{matrix} ] \qquad Eq . 27$$

Accordingly, depending on the complexity of the manufacturing process and network, the methods and systems of the present disclosure may utilize computers and/or their components (e.g., processors) to execute the analyses for minimizing manufacturing costs and responding to real-time fluctuations in the dynamic node specifications and equipment issues.

For example, a system can include a computer system that comprises: one or more processors; and one or more tangible, machine-readable storage media that store machine-readable instructions for executions by the processors, the machine-readable instructions corresponding to one or more of the methods described herein. That is, the methods described herein can be performed on computing devices (or processor-based devices) that include one or more processors; one or more memory devices coupled to the processor(s); and instructions provided to the memory devices, wherein the instructions are executable by the processor(s) to perform the methods (or steps of the methods) described herein. The instructions can be a portion of code on one or more non-transitory computer readable media. Any suitable processor-based device(s) may be utilized for implementing all or a portion of embodiments of the present techniques, including, without limitation to, personal computers, networks of personal computers, laptop computers, computer workstations, mobile devices, multi-processor servers or workstations with (or without) shared memory, high performance computers, virtual machines, virtual devices, and the like. Moreover, embodiments may be implemented on application specific integrated circuits (ASICs) or very large scale integrated (VLSI) circuits.

The terms “non-transitory, computer-readable medium,” “tangible machine-readable medium,” or the like refer to any tangible storage that participates in providing instructions to a processor for execution. Such a medium may take many forms including, but not limited to, non-volatile media, and volatile media. Non-volatile media includes, for example, NVRAM, or magnetic or optical disks. Volatile media includes dynamic memory, such as main memory. Computer-readable media may include, for example, a floppy disk, a flexible disk, hard disk, magnetic tape, or any other magnetic medium, magneto-optical medium, a CD-ROM, any other optical medium, a RAM, a PROM, and EPROM, a FLASH-EPROM, a solid state medium like a holographic memory, a memory card, or any other memory chip or cartridge, or any other physical medium from which a computer can read. When the computer-readable media is configured as a database, it is to be understood that the database may be any type of database, such as relational, hierarchical, object-oriented, and/or the like. Accordingly, exemplary embodiments of the present techniques may be considered to include a tangible storage medium or tangible distribution medium and prior art-recognized equivalents and successor media, in which the software implementations embodying the present techniques are stored.

The computer can implement artificial intelligence techniques to perform iterative-computations and update the quality vectors, multidimensional conversion tensors and/or multidimensional correlation tensors that inter-relate various parts (e.g., the nodes) and data in the manufacturing networks and/or their equivalents in the virtual space. The artificial intelligence techniques can include various types of machine learning techniques, and the like. Further, machine learning techniques may utilize supervised machine learning algorithms, unsupervised machine learning algorithms, and/or reinforcement machine learning algorithms, and the like.

### Example Embodiments

An example embodiment of the present disclosure is a dynamic quality control method for a chemical manufacturing process to maintain one or more products within respective quality and/or technical specification(s), wherein the manufacturing process converts one or more feed-stocks into one or more products via one or more intermediates, the method comprising: measuring properties of the feed-stock, the intermediates, and the products to yield their respective quality vectors; assigning a node specification to each of the feed-stocks, the intermediates, and the products, wherein the node specifications for each of the feed-stocks and the intermediates are dynamic node specifications; calculating conversion tensors to correlate any pairs of node specifications; comparing one or more quality vectors to the corresponding dynamic node specification(s); identifying a quality deficit and/or a quality surplus associated with each of the one or more quality vectors based on the comparison to the corresponding dynamic node specification; and compensating for the quality deficit and/or the quality surplus by (A) adjusting conditions of the manufacturing process in response to the quality deficit and/or the quality surplus and/or (B) compensating quality deficits with corresponding quality surpluses via material transfer and re-blending processes.

Another example embodiment of the present disclosure is a system for providing a chemical manufacturing process to maintain one or more products within a static and/or dynamic quality specification, wherein the manufacturing process converts one or more feed-stocks into one or more products via one or more intermediates, the system comprising: a processor; a non-transitory machine readable medium that stores machine-readable instructions for execution by the processor, the machine-readable instructions comprising: measuring properties of the feed-stock, the intermediates, and the products to yield one or more quality vectors; assigning a node specification to each of the feed-stocks, the intermediates, and the products, wherein the node specifications for each of the feed-stocks and the intermediates are dynamic node specifications; calculating conversion tensors to correlate any pairs of node specifications; comparing one or more quality vectors to the corresponding dynamic node specification(s); identifying a quality deficit and/or a quality surplus associated with each of the one or more quality vectors based on the comparison to the corresponding dynamic node specification(s); and compensating for the quality deficit and/or the quality surplus by (A) adjusting conditions of the manufacturing process in response to the quality deficit and/or the quality surplus and/or (B) compensating quality deficits with corresponding quality surpluses via material transfer and re-blending processes.

The foregoing embodiments can include one or more of the following: Element 1: wherein calculating conversion tensors and/or other associated tensors applies to one or more machine learning techniques; Element 2: wherein one or more of the node specifications include a property selected from the group consisting of: concentrations of selected individual components in the composition, intended purity levels of products, level of contaminants, viscosity, lubricity, freeze point, melting point, flash point, boiling point, energy content, heat value, octane number, cetane number, color, odor, melt index, flow rate index, impact strength, tensile strength, elongation at break, molecular weight characteristics, chirality, and the like, and any combination thereof; Element 3: wherein the conditions of the manufacturing process include a condition selected from the group consisting of: temperature, temperature distribution across zones of a manufacturing unit, pressure, distribution of pressure across zones of a manufacturing unit, material flow rate, split ratios, reactant stoichiometric ratios, reactor efficiency, mixing and separation efficiencies, catalytic contact time, catalyst activity, and any combination thereof; Element 4: wherein the manufacturing process is pharmaceutical manufacturing, commodity chemical manufacturing, specialty chemical manufacturing, petrochemical manufacturing, petroleum refining, or lubricant manufacturing; Element 5: the method or machine-readable instructions further comprising performing iterative-computations for adjusting the conditions of the manufacturing process to account for real-time changes in the dynamic node specifications and the quality vectors to improve efficacy and/or efficiency of the manufacturing process; and updating the dynamic node specifications and conversion tensors and/or other associated tensors based on the iterative-computations; Element 6: the method or machine-readable instructions further comprising performing simultaneous iterative-computations for adjusting the conditions of the manufacturing process to account for real-time changes in the dynamic node specifications and the quality vectors to improve efficacy and/or efficiency of the manufacturing process; and updating the dynamic node specifications and conversion tensors and/or other associated tensors based on the iterative-computations; and Element 7: wherein adjusting the conditions of the manufacturing process is further in response to reducing a manufacturing cost associated with the manufacturing process. Examples of combinations include, but are not limited to, Element 1 in combination with one or more of Elements 2-7; Element 2 in combination with one or more of Elements 3-7; Element 3 in combination with one or more of Elements 4-7; Element 4 in combination with one or more of Elements 5-7; Element 7 in combination with one or more of Elements 5-6; and Element 1 in combination with one or more of Elements 2-7.

Unless otherwise indicated, all numbers expressing quantities of ingredients, properties such as molecular weight, reaction conditions, and so forth used in the present specification(s) and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A dynamic quality control method for a manufacturing process to maintain one or more products within respective quality and/or technical specification(s), wherein the manufacturing process converts one or more feed-stocks into one or more products via one or more intermediates, the method comprising:
measuring properties of the feed-stock, the intermediates, and the products to yield their respective quality vectors;
assigning a node specification to each of the feed-stocks, the intermediates, and the products, wherein the node specifications for each of the feed-stocks and the intermediates are dynamic node specifications;
calculating conversion tensors to correlate any pairs of node specifications;
comparing one or more quality vectors to the corresponding dynamic node specification(s);
identifying a quality deficit and/or a quality surplus associated with each of the one or more quality vectors based on the comparison to the corresponding dynamic node specification; and
compensating for the quality deficit and/or the quality surplus by (A) adjusting conditions of the manufacturing process in response to the quality deficit and/or the quality surplus and/or (B) compensating quality deficits with corresponding quality surpluses via material transfer and re-blending processes.

2. The method according to claim 1, wherein calculating conversion tensors and/or other associated tensors applies to one or more machine learning techniques.

3. The method according to claim 1, wherein one or more of the node specifications include a property selected from the group consisting of: concentrations of selected individual components in the composition, intended purity levels of products, level of contaminants, viscosity, lubricity, freeze point, melting point, flash point, boiling point, energy content, heat value, octane number, cetane number, color, odor, melt index, flow rate index, impact strength, tensile strength, elongation at break, molecular weight characteristics, chirality, and the like, and any combination thereof.

4. The method according to claim 1, wherein the conditions of the manufacturing process include a condition selected from the group consisting of: temperature, temperature distribution across zones of a manufacturing unit, pressure, distribution of pressure across zones of a manufacturing unit, material flow rate, split ratios, reactant stoichiometric ratios, reactor efficiency, mixing and separation efficiencies, catalytic contact time, catalyst activity, and any combination thereof.

5. The method according to claim 1, wherein the manufacturing process is pharmaceutical manufacturing, commodity chemical manufacturing, specialty chemical manufacturing, petrochemical manufacturing, petroleum refining, or lubricant manufacturing.

6. The method according to claim 1, further comprising:
performing iterative-computations for adjusting the conditions of the manufacturing process to account for real-time changes in the dynamic node specifications and the quality vectors to improve efficacy and/or efficiency of the manufacturing process; and
updating the dynamic node specifications and conversion tensors and/or other associated tensors based on the iterative-computations.

7. The method according to claim 1, wherein adjusting the conditions of the manufacturing process is further in response to reducing a manufacturing cost associated with the manufacturing process.

8. A system for providing a manufacturing process to maintain one or more products within a static and/or dynamic quality specification, wherein the manufacturing process converts one or more feed-stocks into one or more products via one or more intermediates, the system comprising:
a processor;
a non-transitory machine readable medium that stores machine-readable instructions for execution by the processor, the machine-readable instructions comprising:
measuring properties of the feed-stock, the intermediates, and the products to yield one or more quality vectors;
assigning a node specification to each of the feed-stocks, the intermediates, and the products, wherein the node specifications for each of the feed-stocks and the intermediates are dynamic node specifications;
calculating conversion tensors to correlate any pairs of node specifications;
comparing one or more quality vectors to the corresponding dynamic node specification(s);
identifying a quality deficit and/or a quality surplus associated with each of the one or more quality vectors based on the comparison to the corresponding dynamic node specification(s); and
compensating for the quality deficit and/or the quality surplus by (A) adjusting conditions of the manufacturing process in response to the quality deficit and/or the quality surplus and/or (B) compensating quality deficits with corresponding quality surpluses via material transfer and re-blending processes.

9. The system according to claim 8, wherein the instruction of calculating conversion tensors and/or other associated tensors applies to one or more machine learning techniques.

10. The system according to claim 8, wherein one or more of the node specifications include a property selected from the group consisting of: concentrations of selected individual components in the composition, intended purity levels of products, level of contaminants, density viscosity, lubricity, freeze point, melting point, flash point, boiling point, energy content, heat value, octane number, cetane number, color, odor, melt index, flow rate index, impact strength, tensile strength, elongation at break, molecular weight characteristics, chirality, and the like, and any combination thereof.

11. The system according to claim 8, wherein the conditions of the manufacturing process include a condition selected from the group consisting of: temperature, temperature distribution across zones of a manufacturing unit, pressure, distribution of pressure across zones of a manufacturing unit, material flow rate, split ratios, reactant stoichiometric ratios, reactor efficiency, mixing and separation efficiencies, catalytic contact time, catalyst activity, and any combination thereof.

12. The system according to claim 8, wherein the chemical manufacturing process is pharmaceutical manufacturing, commodity chemical manufacturing, specialty chemical manufacturing, petrochemical manufacturing, petroleum refining, or lubricant manufacturing.

13. The system according to claim 8, wherein the machine-readable instructions further comprise:
perform iterative-computations for adjusting the conditions of the manufacturing process to account for real-time changes in the dynamic node specifications and the quality vectors to improve an efficacy and/or an efficiency of the manufacturing process; and
update the dynamic node specifications and conversion tensors and/or other associated tensors based on the iterative-computations.

14. The system according to claim 8, wherein adjusting the conditions of the manufacturing process is further in response to reducing a manufacturing cost associated with the manufacturing process.
